(19) United States
(12) Patent Application Publication
(10) Pub. No.: US 2013/0346678 A1
(43) Pub. Date: Dec. 26, 2013

(54) MEMORY EXPANDING DEVICE

(71) Applicant: SAMSUNG ELECTRONICS CO., LTD., Gyeonggi-Do (KR)

(72) Inventors: Ein-Sung JO, Hwasung City (KR); Sei-Jin KIM, Hwasung City (KR); Ha-Ryong YOON, Hwasung City (KR); Kyoung-Ho HA, Hwasung City (KR)

(73) Assignee: SAMSUNG ELECTRONICS CO., LTD., Gyeonggi-do (KR)

(21) Appl. No.: 13/804,076

(22) Filed: Mar. 14, 2013

(30) Foreign Application Priority Data
Jun. 21, 2012 (KR) 10-2012-0066523

(51) Int. Cl. G06F 3/06; G06F 12/02

(52) U.S. Cl. CPC G06F 3/0604; G06F 12/0246
USPC 711/103; 711/105; 711/154

(57) ABSTRACT

A memory expanding device includes an input and output part coupleable to an external optical interface, a controller coupled to the input and output part through a first internal optical interface, a main memory module coupled to the controller through a second internal optical interface, and a sub-memory module coupled to the controller through a first internal electrical interface.

### CROSS-REFERENCE TO RELATED APPLICATION

The present application claims priority under 35 U.S.C. §119 to Korean Patent Application No. 10-2012-0066523, filed on Jun. 21, 2012, in the Korean Intellectual Property Office, and entitled: “Memory Expanding Device,” which is incorporated by reference herein in its entirety.

### BACKGROUND

Due to technological development of a microprocessor unit (MPU) and a memory chip, data processing capacity of a system module is increased. Accordingly, interfacing technology of high speed and high density is sought for a central processing unit (CPU) and a main memory module to process the increased amount of the data.

### SUMMARY

Embodiments may be realized by providing a memory expanding device that includes an input and output part coupleable to an external optical interface, a controller coupled to the input and output part through a first internal optical interface, a main memory module coupled to the controller through a second internal optical interface, and a sub-memory module coupled to the controller through a first internal electrical interface.

The input and output part may be coupleable to an external electrical interface to exchange information with the sub-memory module through the external electrical interface. The controller may be coupled to the main memory module through a second internal electrical interface. The controller and the main memory module may transfer data with each other through the second internal optical interface. The controller and the main memory module may transfer information that excludes the data with each other through the second internal electrical interface.

The controller may include a signal processor coupled to the input and output part through the first internal optical interface, a main memory controller coupled to the signal processor through a third internal optical interface, and a sub-memory controller coupled to the signal processor through a third internal electrical interface. The signal processor may include a data converter configured to convert an optical signal into an electrical signal or to convert an electrical signal into an optical signal.

The main memory module may include a dynamic random access memory (DRAM) module or a magneto-resistive random access memory (MRAM) module.

Embodiments may also be realized by providing a memory expanding device that includes an input and output part coupleable to an external optical interface, a controller coupled to the input and output part through a first internal optical interface, a DRAM module coupled to the controller through a second internal optical interface, and a flash memory module coupled to the controller through a first internal electrical interface or a second internal electrical interface.

When the flash memory module is coupled to the first internal electrical interface, the controller may include a signal processor coupled to the input and output part through the first internal optical interface, a DRAM controller coupled to the signal processor through a third internal optical interface, and a flash memory controller coupled to the signal processor through the second internal electrical interface. The signal processor may include a data converter configured to convert an optical signal from the input and output part into an electrical signal provided to the flash memory or to convert an electrical signal from the flash memory into an optical signal provided to the input and output part.

When the flash memory module is coupled to the second internal electrical interface, the controller may include a signal processor that is coupled to the input and output part through the first internal optical interface, a DRAM controller coupled to the signal processor through a third internal optical interface and the second internal electrical interface, and a flash memory controller coupled to the signal processor through a fourth internal electrical interface. The signal processor may include a data converter configured to convert an optical signal from the input and output part into an electrical signal provided to the DRAM memory or the flash memory or to convert an electrical signal from the DRAM memory or the flash memory into an optical signal provided to the input and output part. The signal processor and the DRAM may transfer data with each other through the third internal optical interface.

Embodiments may also be realized by providing a memory expanding device removeably coupled to an external interface, in which the memory expanding device includes a main memory module coupled to an controller through an internal optical interface, in which the main memory module includes a plurality of first memory modules and is in communication with the external interface, and a sub-memory module coupled to the controller through an internal electrical interface, in which the sub-memory module includes a plurality of second memory modules that are separate from the first memory modules and the sub-memory module is in communication with the external interface.

The first memory modules may be volatile memory modules, and the second memory modules may be non-volatile memory modules. The sub-memory module may only be coupled to the controller through the internal electrical interface, and the main memory module may be coupled to the controller through the internal optical interface and another internal electrical interface.

When the memory expanding device is coupled to the external interface, the controller may be coupled to the external interface through another internal optical interface that is separate from the internal optical interface and the internal electrical interface. The controller may control the first memory modules through an optical interface within the controller and an electrical interface within the controller. The controller may control the second memory modules through the electrical interface within the controller.

The external interface may be an external optical interface. The controller may include a data converter configured to convert an optical signal into an electrical signal provided to second memory modules and may be configured to convert an electrical signal from the second memory modules into an optical signal.

### BRIEF DESCRIPTION OF THE DRAWINGS

Features will become apparent to those of ordinary skill in the art by describing in detail exemplary embodiments with reference to the attached drawings in which:

FIG. 1 illustrates a block diagram of a memory expanding device according to example embodiments.

FIG. 2 illustrates a block diagram of an exemplary optical input and output part included in the memory expanding device of FIG. 1.

FIG. 3 illustrates a block diagram of an exemplary controller included in the memory expanding device of FIG. 1.

FIG. 4 illustrates a block diagram of an exemplary signal processor included in the controller of FIG. 3.

FIGS. 5A and 5B illustrate block diagrams of an exemplary data converter included in the signal processor of FIG. 4.

FIGS. 6A and 6B illustrate block diagrams of an exemplary memory system including a DRAM controller and DRAM module.

FIGS. 7A and 7B illustrate block diagrams of an exemplary memory system including a flash controller and flash module.

FIG. 8 illustrates a block diagram of a memory expanding device according to example embodiments.

FIG. 9 illustrates a block diagram of an exemplary controller included in the memory expanding device of FIG. 8.

FIG. 10 illustrates a block diagram of an exemplary signal processor included in the controller of FIG. 9.

FIGS. 11A and 11B illustrate block diagrams of an exemplary memory system including a DRAM controller and DRAM module.

FIG. 12 illustrates a block diagram of a memory expanding device according to example embodiments.

FIG. 13 illustrates a block diagram of an exemplary electrical input and output part included in the memory expanding device of FIG. 12.

FIG. 14 illustrates a block diagram of an exemplary controller included in the memory expanding device of FIG. 12.

FIG. 15 illustrates a block diagram of an exemplary signal processor included in the controller of FIG. 14.

FIG. 16 illustrates a block diagram of a memory expanding device according to example embodiments.

FIG. 17 illustrates a block diagram of an exemplary controller included in the memory expanding device of FIG. 16.

FIG. 18 illustrates a block diagram of an exemplary a signal processor included in the controller of FIG. 17.

FIG. 19 illustrates a block diagram of an exemplary electronic device including the memory expanding device according to example embodiments.

FIG. 20 illustrates a block diagram of another example of an electronic device including the memory expanding device according to example embodiments.

FIG. 21 illustrates an exemplary mobile phone including the memory expanding device according to example embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawings, the sizes and relative sizes of layers and regions may be exaggerated for clarity. Like numerals refer to like elements throughout. It will be understood that, although the terms first, second, third etc. may be used herein to describe various elements, these elements should not be limited by these terms. These terms are used to distinguish one element from another. Thus, a first element discussed below could be termed a second element without departing from the teachings. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

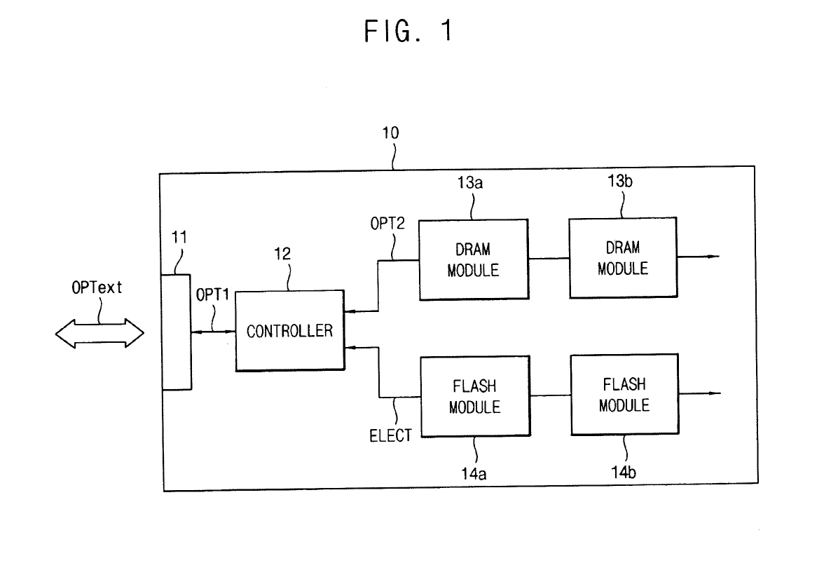

FIG. 1 illustrates a block diagram of a memory expanding device according to example embodiments.

Referring to FIG. 1, a memory expanding device 10 may be coupled to an external optical interface OPText, so that the memory expanding device 10 may exchange information with an external device using an optical signal. The information may include, e.g., data, command, clock signal, power supply, address and the like. The external optical interface OPText may include, e.g., an optical fiber or a silicon photonic element implemented on a silicon substrate. The memory expanding device 10 may include a memory card or a like storage device.

The memory expanding device 10 may include an input and output part 11. The input and output part 11 may be coupled to the external optical interface OPText, a controller 12, a plurality of DRAM modules 13a and 13b, and a plurality of flash modules 14a and 14b. The plurality of DRAM modules 13a and 13b, and the plurality of flash modules 14a and 14b, may be formed in a repeating pattern within the memory expanding device 10.

The DRAM modules 13a and 13b may constitute a main memory performing function of a main memory device, e.g., may together constitute a main memory module. For example, the DRAM modules 13a and 13b may include a volatile memory, e.g., a static random access memory (SRAM), or a non-volatile memory, e.g., a magneto-resistive random access memory (MRAM). For example, the DRAM modules 13a and 13b may be used for processing data and/or as temporary storage.

The flash modules 14a and 14b may constitute a sub-memory performing function of a massive memory device (e.g., a large capacity storage device). For example, the flash modules 14a and 14b may include a non-volatile memory, e.g., a resistive random access memory (RRAM) or a phase change random access memory (PRAM). The flash modules 14a and 14b may be a different type of memory in comparison with the DRAM modules 13a and 13b. For example, the flash modules 14a and 14b may be used for data storage.

The controller 12 may be coupled to the input and output part 11 through a first internal optical interface OPT1. The controller 12 may be coupled to the DRAM modules 13a and 13b through a second internal optical interface OPT2, e.g., the DRAM modules 13a and 13b may be connected in series. The controller 12 may be coupled to the flash modules 14a and 14b through an internal electrical interface ELECT, e.g., the flash modules 14a and 14b may be connected in series. The second internal optical interface OPT2 may be separate from the internal electrical interface ELECT.

The internal optical interfaces OPT1 and OPT2 of the memory expanding device 10 may include, e.g., an optical fiber or a silicon photonic element. For example, the DRAM modules 13a and 13b may be coupled through the silicon photonic element or the optical fiber outside the modules 13a and 13b. Each of the modules 13a and 13b may include a socket and an optical-electrical/electrical-optical conversion element coupled to the silicon photonic element or the optical fiber. In this case, an optical signal may be transferred through the silicon photonic element or the optical fiber between the modules 13a and 13b, and an electronic signal may be transferred inside the modules 13a and 13b. In some embodiments, the silicon photonic element or the optical fiber may be extended into at least a portion of each module.

The flash modules 14a and 14b have relatively low operating speed compared to the DRAM modules 13a and 13b, so that the flash modules 14a and 14b may be coupled through the internal electrical interface ELECT. According to an exemplary embodiment, a portion of the internal electrical interface ELECT may correspond to an optical interface to transfer a portion of information such as data that require high speed processing.

The modules 13a, 13b, 14a, and 14b may be implemented such that a user may easily remove or exchange the modules, e.g., the memory expanding device 10 including the modules 13a, 13b, 14a, and 14b may be removably coupled to an external device. In the case of a non-removable board, the modules 13a, 13b, 14a and 14b may be coupled through additional connectors.

The performance of the system may be improved using the memory expanding device 10 regardless of a capacity of an internal DRAM mounted in the system and a speed and a capacity of a hard disk drive (HDD). Also, personal information may be stored in the flash memory modules for easy portability. Accordingly, when the user uses a public computer, multiple computers, or mobile devices, the personal data may be managed conveniently.

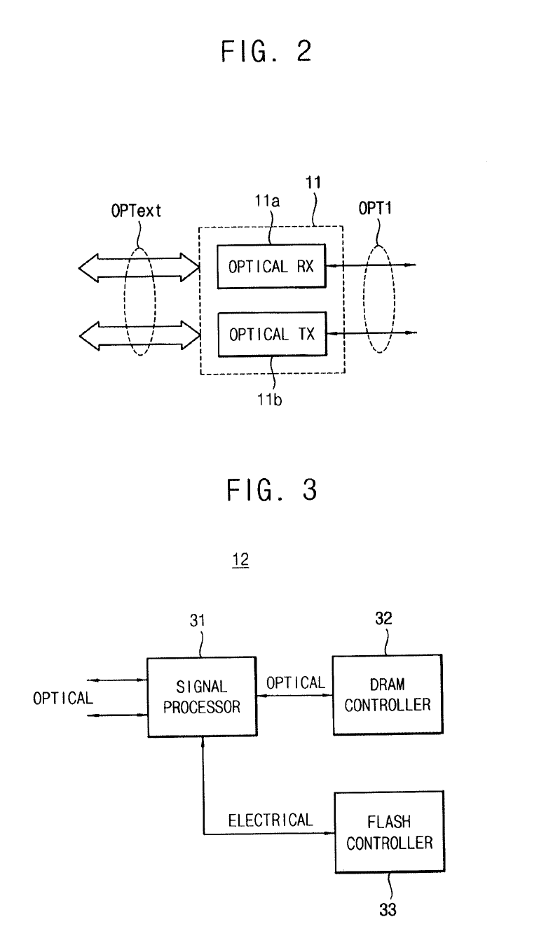

FIG. 2 illustrates a block diagram of an example of an optical input and output part 11 included in the memory expanding device of FIG. 1.

Referring to FIG. 2, the optical input and output part 11 may include an optical receiving part 11a and an optical transmitting part 11b. When information is exchanged between the external optical interface OPText and the first internal optical interface OPT1, the optical receiving part 11a and the optical transmitting part 11b perform a function of, e.g., driving, buffering, synchronizing, and/or the like.

FIG. 3 illustrates a block diagram of an example of a controller included in the memory expanding device of FIG. 1.

Referring to FIG. 3, the controller 12 may include a signal processor 31 coupled to the input and output part 11 through an internal optical interface. For example, the first internal optical interface OPT1, a DRAM controller 32 coupled to the signal processor 31 through an optical interface, and a flash controller 33 coupled to the signal processor 31 through an electrical interface.

The signal processor 31 may transfer, e.g., exclusively transfer, information concerned with DRAM through the optical interface and information concerned with flash memory through the electrical interface. Accordingly, the signal processor 31 may support both the optical interface and the electrical interface. The signal processor 31 may be implemented, such that that the information of the two interfaces may be adapted for use with each other.

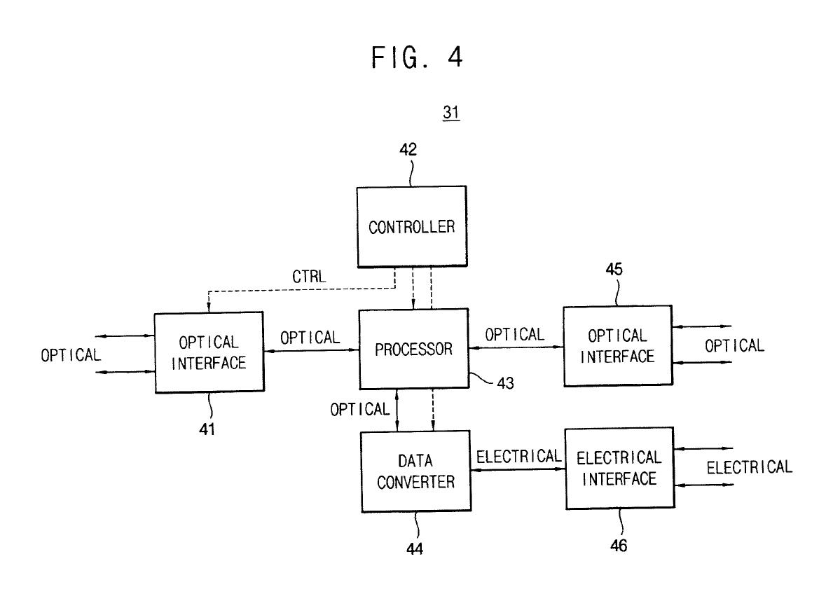

FIG. 4 illustrates a block diagram illustrating an example of a signal processor included in the controller of FIG. 3.

Referring to FIG. 3, the signal processor 31 may include an optical interface unit 41 coupled to the input and output part 11 through an optical interface, e.g., through the first internal optical interface OPT1. The signal processor 31 may include a processor 43 coupled to the optical interface unit 41, an optical interface unit 45 transmitting an optical signal between the processor 43 and the DRAM, e.g., through the second internal optical interface OPT2. The signal processor 31 may include a data converter 44 that exchanges an optical signal with the processor 43, and that converts an optical signal to an electrical signal or that converts an electrical signal to an optical signal. The signal processor 31 may include an electrical interface unit 46 that transmits an electrical signal between the data converter 44 and the flash memory, e.g., through the internal electrical interface ELECT.

Information may be exchanged through the optical interface between the processor 43 and the data converter 44. The controller 42 controls each block through control signals CTRL. The control signal CTRL may be transferred through the electrical interface or the optical interface.

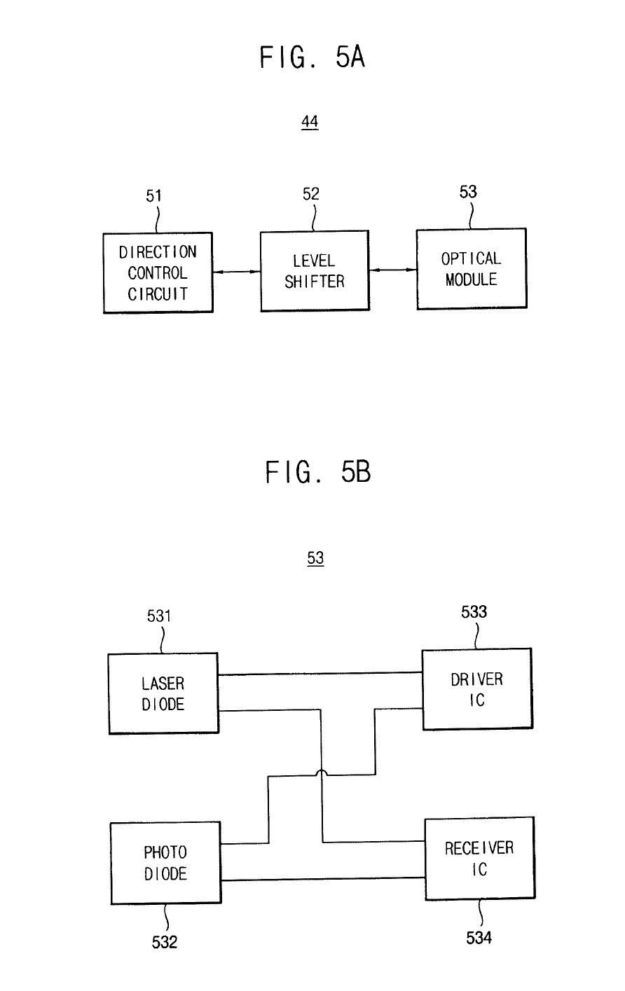

FIGS. 5A and 5B illustrate block diagrams of an example of a data converter included in the signal processor of FIG. 4.

In particular, FIG. 5A illustrates a detailed block diagram of the data converter 44. The optical signal may be transferred between the processor 43 and the data converter 44. The data converter 44 may include optical receiving and transmitting parts, e.g., similar to the optical receiving part 11a and the optical transmitting part 11b of FIG. 2.

Each of the optical receiving part and the optical transmitting part, e.g., each of optical receiving and transmitting parts 11a and 11b, may include a direction control circuit 51, a level shifter 52 and an optical module 53. For example, the optical receiving part and the optical transmitting part may have same internal components and a symmetrical structure with each other. Since an operation of the optical receiving part is a reverse operation of the optical transmitting part, the operation of the optical transmitting part is mainly described, and the repeated descriptions may be omitted.

In a system based on an electrical signal through a bus such as universal serial bus (USB), an upstream data and a downstream data are transferred through the same channel. However, in an optical transmitting interface, although the upstream data and the downstream data share the same bus line, the upstream data and the downstream data may be transferred through different channels.

The direction control circuit 51 may isolate the data inputted from the controller 42. For example, the direction control circuit 51 isolates the data into the upstream data and the downstream data, and then transfers the isolated data to the level shifter 52.

The level shifter 52 may convert a level of the data transferred from the direction control circuit 51. A signal level of a driving IC used in the controller 42 and the direction control circuit 51 may be different from a signal level of a driving IC used in the optical module 53. The level shifter 52 matches the two signal levels.

The optical module 53 may convert the data adjusted by the level shifter 52 to an optical signal. The optical module 53 may include a photo diode for electrical-to-optical conversion. The optical module 53 outputs a converted optical signal, e.g., to the electrical interface 46.

FIG. 5B illustrates a block diagram of an internal block of the optical module 53 in FIG. 5A. Referring to FIG. 5B, the optical module 53 may include a laser diode 531, a photo diode 532, a receiver IC 534, and a driver IC 533.

The optical module 53 may convert an optical signal to a high speed electrical signal through the photo diode 532 and the receiver IC 534. The electrical signal converted in the optical module 53 may be transferred to the electrical interface unit 46 in FIG. 4.

The photo diode 532 operates in response to an inputted optical signal and converts the inputted optical signal to a corresponding electrical signal. The receiver IC 534 amplifies and restores an electrical signal converted in the photo diode 532. The electrical signal outputted from the photo diode 532 may be weak, and thus the electrical signal outputted from the photo diode 532 may be amplified for reliable processing of the electrical signal.

The receiver IC 534 may include a pre-amplifier and a limiting amplifier. The pre-amplifier and the limiting amplifier amplify an electrical signal converted in the photo diode 532. The pre-amplifier and the limiting amplifier may reduce the possibility of and/or prevent noise and crosstalk caused in the process of amplifying.

The optical module 53 may convert a high speed electrical signal to an optical signal through the laser diode 531 and the driver IC 533. The optical signal converted in the optical module 53 may be transferred to the processor 43 in FIG. 4.

The laser diode 531 operates in response to an inputted electrical signal and converts the inputted electrical signal to a corresponding optical signal. The laser diode 531 converts the electrical signal from the optical interface 46 to an optical signal. In this case, the driver IC 533 is electrically connected to the laser diode 531, so that the driver IC 533 drives the laser diode 531.

The receiver IC 534 and the driver IC 533 may be implemented as a system integrated (SI) chip. A portion of the functions of the receiver IC 534 and the driver IC 533 may be common, e.g., may be shared. Therefore, the receiver IC 534 and the driver IC 533 may be implemented as one receiving-transmitting module so that the receiver IC 534 and the driver IC 533 share elements associated with the common functions.

As mentioned above, the data converter 44 may convert an optical signal transferred from the processor 43 to an electrical signal, and then may transfer the electrical signal to the electrical interface unit 46. In addition, the data converter 44 may convert an electrical signal transferred from the electrical interface unit 46 to an optical signal, and then may transfer the optical to the processor 43. In other word, the data converter 44 may perform bi-directional conversion, that is, a conversion from an electrical signal to an optical signal and a conversion from an optical signal to an electrical signal.

The electrical signal converted in the data converter 44 may correspond to an optical signal that is communicated through an optical signal system. Therefore, the converted electrical signal should be converted to correspond to the electrical signal system used in the controller 42. The data converter 44 or the electrical interface unit 46 may include serializer and deserializer (SerDes), multiplexer (Mux) and the like, so that the electrical signal may be serialized or deserialized, and matched with the corresponding optical signal. Also, the similar descriptions may be applied to an opposite case, that is, the conversion from the optical signal to the electrical signal.

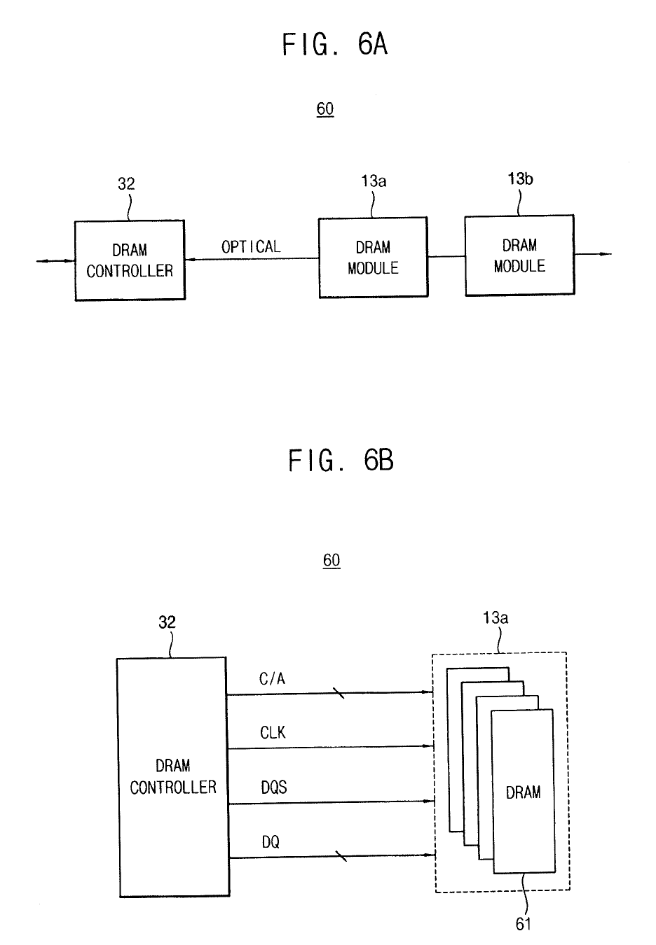

FIGS. 6A and 6B illustrate block diagrams of a memory system including a DRAM controller and DRAM module.

Referring to FIG. 6A, the memory system 60 may include a DRAM controller 32 and the DRAM modules 13a and 13b. The DRAM controller 32 and the DRAM modules 13a and 13b may be coupled through an optical interface. The optical interface may include an optical fiber disposed outside the DRAM modules 13a and 13b, and a silicon photonic element extended to inside the DRAM modules 13a and 13b or inside the DRAM chips.

Referring to FIG. 6B, the memory system 60 may include a DRAM controller 32 and the DRAM module 13a having a plurality of DRAM chips 61. Similarly, DRAM module 13b may have a plurality of DRAM chips 61. The DRAM controller 32 and the plurality of DRAM chips 61 exchange information, e.g., such as a command/address (C/A), a clock (CLK), a data strobe (DQS), and/or a data (DQ), through an optical interface.

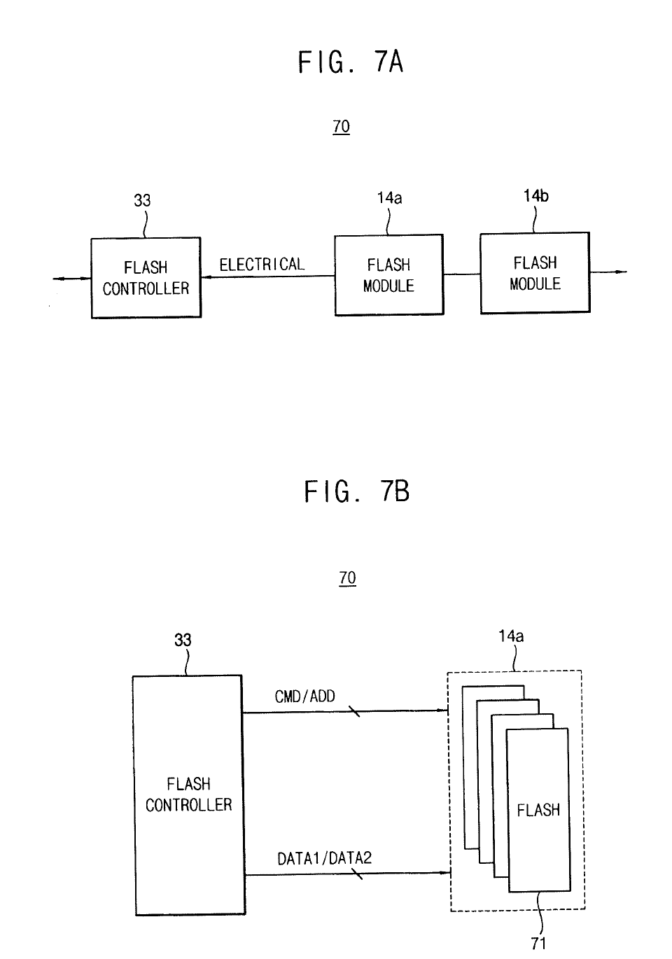

FIGS. 7A and 7B illustrate block diagrams of a memory system including a flash controller and flash module.

Referring to FIG. 7A, the memory system 70 may include a flash controller 33 and the flash modules 14a and 14b. The flash controller 33 and the flash modules 14a and 14b may be coupled through an electrical interface.

Referring to FIG. 7B, the memory system 70 may include a flash controller 33 and the flash module 14a having a plurality of flash chips 71. Similarly, the flash module 14b may have a plurality of flash chips 71. The flash controller 33 and the plurality of a flash chip 71 exchange information, e.g., such as a command/address (CMD/ADD) and/or a data (DATA1/DATA2Q), through an electrical interface.

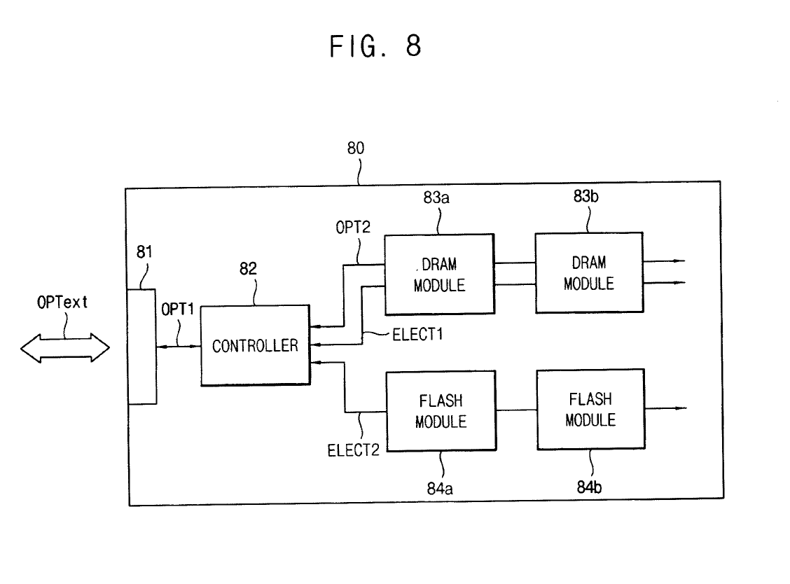

FIG. 8 illustrates a block diagram of a memory expanding device according to example embodiments. Since an example embodiment of FIG. 8 includes similar components of the example embodiment of FIG. 1, the repeated descriptions may be omitted.

Referring to FIG. 8, the memory expanding device 80 exchanges information with an external device through an external optical interface OPText. The memory expanding device 80 may include an input and output part 81 coupled to the external optical interface OPText, a controller 82, a plurality of DRAM modules 83a and 83b, and a plurality of flash modules 84a and 84b.

The controller 82 may be coupled to the input and output part 81 through a first internal optical interface OPT1. Also, the controller 82 may be coupled to the DRAM modules 83a and 83b through a second internal optical interface OPT2 and a first internal electrical interface ELECT1. The controller 82 may be further coupled to the flash modules 84a and 84b through a second internal electrical interface ELECT2.

In the case of the DRAM modules 83a and 83b, specific information, such as a data, may be exchanged through the optical interface, e.g., through the second internal optical interface OPT2. The DRAM modules 83a and 83b may be coupled to the optical interface through an optical fiber, and a socket and an optical-electrical conversion element may be equipped in the DRAM modules 83a and 83b. Other information, such as a power supply, a command and the like, may be exchanged through an electrical interface, e.g., through the first internal electrical interface ELECT1.

The flash modules 84a and 84b may be coupled through an electrical interface, e.g., the second internal electrical interface ELECT2. Although not shown in FIG. 8, when specific information requiring high operation speed, such as data, may be exchanged through an additional optical interface between the controller 82 and the flash modules 84a and 84b.

The modules 83a, 83b, 84a, and 84b may be implemented so that a user may easily remove or exchange the modules. In the case of a non-removable board, the modules 83a, 83b, 84a, and 84b may be coupled through additional connectors.

The configuration of the optical input and output part 81 may be substantially the same as the configuration of FIG. 2, and the repeated descriptions may be omitted.

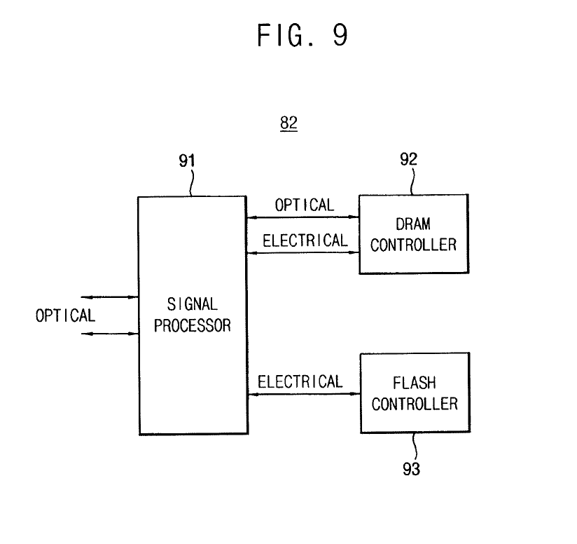

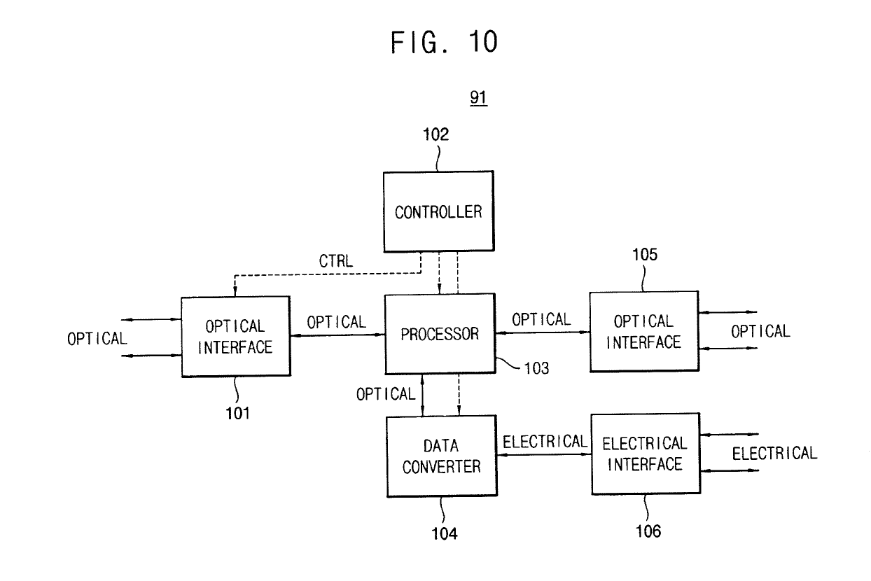

FIG. 9 illustrates a block diagram of an example of a controller included in the memory expanding device of FIG. 8. Referring to FIG. 9, the controller 82 may include a signal processor 91 coupled to the optical input and output part 81 through an internal optical interface, a DRAM controller 92 coupled to the signal processor 91 through an optical interface and an electrical interface, and a flash controller 93 coupled to the signal processor 91 through an electrical interface.

When specific information requiring relatively high operation speed, such as a data, is exchanged, the signal processor 91 may be coupled through an optical interface. When other information requiring relatively low operation speed, such as a power supply, a command and the like, is exchanged, the signal processor 91 may be coupled through an electrical interface. Also, when information concerned with flash is exchanged, the signal processor 91 may be coupled through an electrical interface. Therefore, the signal processor 91 may support both of the optical interface and the electrical interface. The signal processor 91 may be implemented so that information concerned with the optical interface and the electrical interface is adapted for use with each other.

FIG. 10 illustrates a block diagram of an example of a signal processor included in the controller of FIG. 9.

Referring to FIG. 10, the signal processor 91 may include an optical interface unit 101 coupled to the input and output part 81, a processor 103 coupled to the optical interface unit 101, an optical interface unit 105 transferring an optical signal between the processor 103 and a DRAM, and an electrical interface unit 106 transferring an electrical signal between the processor 103, a DRAM and a flash memory. The signal processor 91 may include a data converter 104 that exchanges an optical signal with the processor 103, and that converts the optical signal to the electrical signal or that converts the electrical signal to the optical signal.

The configuration of the data converter 104 may be substantially the same as the configuration of FIG. 5A, the repeated descriptions may be omitted.

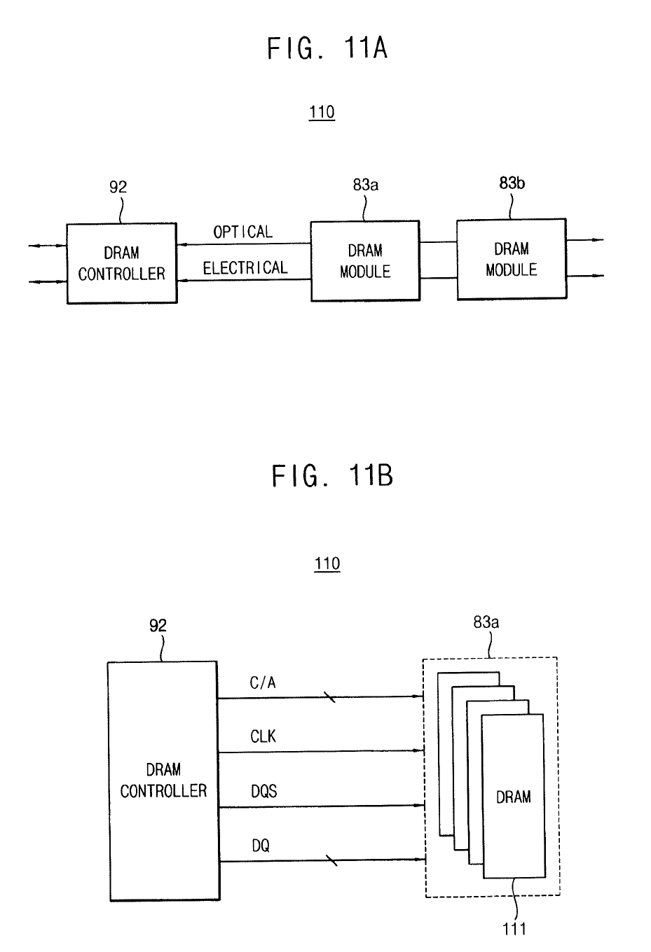

FIGS. 11A and 11B illustrate block diagrams of a memory system including a DRAM controller and DRAM module.

Referring to FIG. 11A, the memory system 110 may include a DRAM controller 92 and the DRAM modules 83a and 83b. The DRAM controller 92 and the DRAM modules 83a and 83b may be coupled through both an optical interface and an electrical interface.

The optical interface may include an optical fiber disposed on the outside of the DRAM modules 83a and 83b, a silicon photonic element extended to inside of the DRAM modules 83a and 83b or inside of the DRAM chip. The optical interface may be used to transfer information requiring relatively high transfer speed, such as a data.

The electrical interface equipped with the optical interface may be used to transfer information requiring relatively low transfer speed, such as a command, an address, a power supply, and the like.

Referring to FIG. 11B, the memory system 110 may include a DRAM controller 92 and a DRAM module 83a having a plurality of DRAM chips 111. Information, such as a command/address (C/A), a clock (CLK), a data strobe (DQS) and a data (DQ), may be exchanged between the DRAM controller 92 and the plurality of DRAM chips 111.

For example, the data (DQ) is transferred through an optical interface, and the command/address (C/A), the clock (CLK) and the data strobe (DQS) are transferred through an electrical interface. In other embodiments, the electrical interface may be transformed into various forms different from the aforementioned configurations. For example, the data strobe (DQS), and the command/address (C/A) and the clock (CLK) are transferred through an optical interface, and only the power supply is transferred through an electrical interface.

Since a configuration of the memory system including a flash controller and a flash module is substantially the same as a configuration shown in FIG. 7, the repeated descriptions may be omitted.

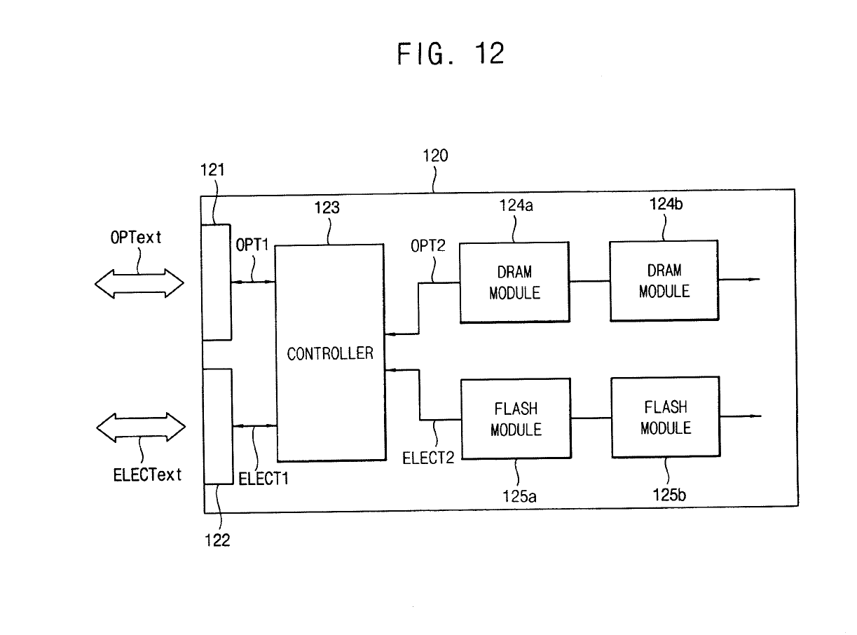

FIG. 12 illustrates a block diagram of a memory expanding device according to example embodiments. Since an example embodiment of FIG. 12 includes similar components of the example embodiment of FIGS. 1 and 8, the repeated descriptions may be omitted.

Referring to FIG. 12, the memory expanding device 120 may exchange information through an external optical interface OPText and an external electrical interface ELECText. Therefore, the memory expanding device 120 may include both of an optical input and output part 121 coupled to the external optical interface OPText and an electrical input and output part 122 coupled to the external electrical interface ELECText. The memory expanding device 120 may also include a controller 123 that is connected to both the optical input and output part 121 and the electrical input and output part 122.

The memory expending device 120 may include a plurality of DRAM modules 124a and 124b and a plurality of flash modules 125a and 125b. The DRAM modules 124a and 124b may represent a main memory performing part of a main memory device. The flash modules 125a and 125b may represent a sub-memory performing part of a massive storage device.

The controller 123 may be coupled to the optical input and output part 121 through a first internal optical interface OPT1, and may be coupled to the electrical input and output part 122 through a first internal electrical interface ELECT 1. The controller 123 may be coupled to the DRAM modules 124a and 124b through a second internal optical interface OPT2, and may be coupled to the flash modules 125a and 125b through a second internal electrical interface ELECT2.

The modules 124a, 124b, 134a, and 134b may be implemented so that a user can easily remove or exchange the modules. In the case of a non-removable board, the modules 124a, 124b, 134a, and 134b may be coupled through additional connectors. Since a configuration of the optical input and output part 121 may be substantially the same as a configuration shown in FIG. 2, the repeated descriptions may be omitted.

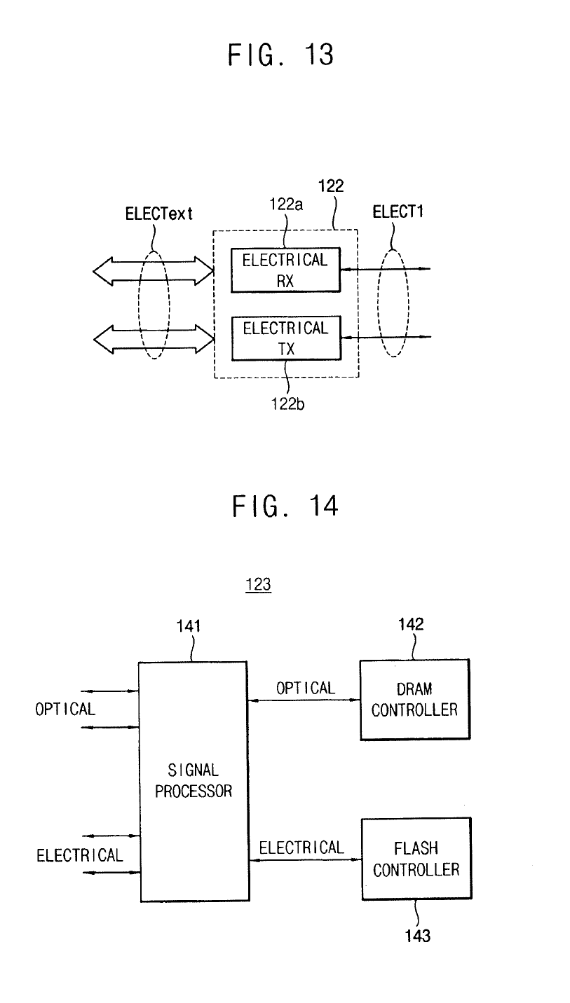

FIG. 13 illustrates a block diagram of an example of an electrical input and output part included in the memory expanding device of FIG. 12.

Referring to FIG. 13, the electrical input and output part 122 includes an electrical receiving part 122a and an electrical transmitting part 122b coupled to an external electrical interface ELECText and a first internal electrical interface ELECT1. When the electrical receiving part 122a and the electrical transmitting part 122b exchange information between the external electrical interface ELECText and a first internal electrical interface ELECT1, the electrical receiving part 122a and the electrical transmitting part 122b may perform the function of driving, buffering, synchronizing of the transferred information, and/or the like.

FIG. 14 illustrates a block diagram of an example of a controller included in the memory expanding device of FIG. 12.

Referring to FIG. 14, the controller 123 may include a signal processor 141 coupled to the optical input and output part 121 and the electrical input and output part 122 through an internal optical interface and an internal electrical interface, respectively. The controller 123 may include a DRAM controller 142 coupled to the signal processor 141 through an optical interface and a flash controller 143 coupled to the signal processor 141 through an electrical interface.

The signal processor 141 may transfer information concerned with DRAM memory through the optical interface and information concerned with flash memory through the electrical interface. Therefore, the signal processor 141 supports both of the two interfaces.

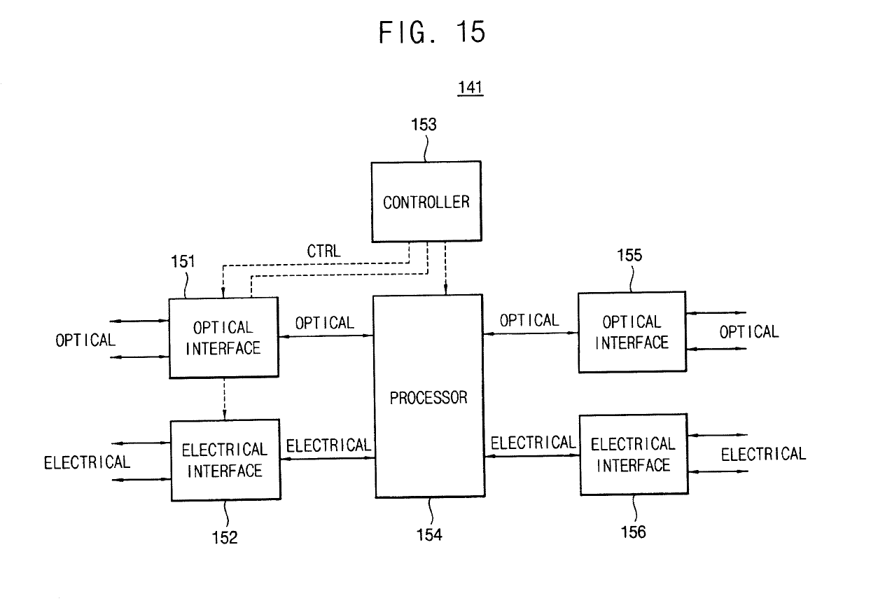

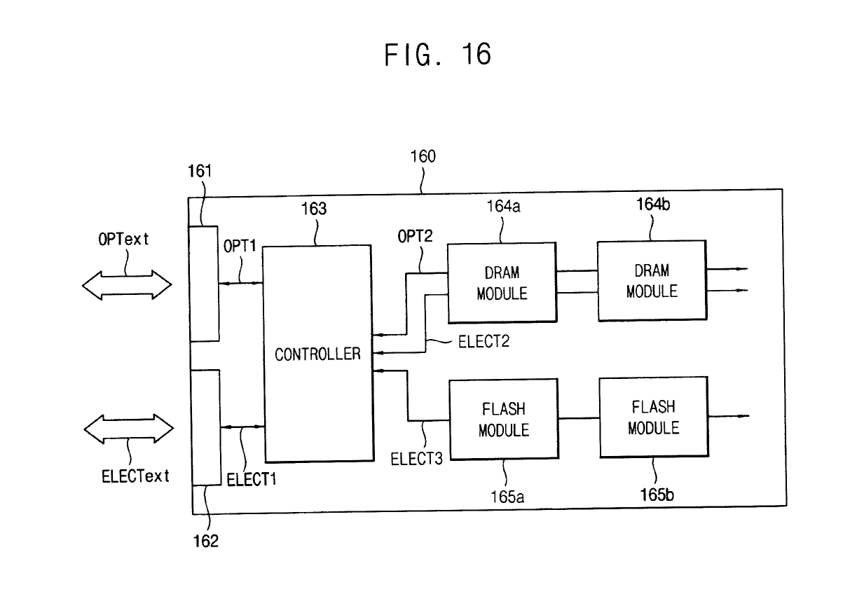

FIG. 15 illustrates a block diagram of an example of a signal processor included in the controller of FIG. 14.

Referring to FIG. 15, the signal processor 141 may include a first optical interface unit 151 (e.g., coupled to the optical input and output part 121), a processor 154 coupled to the optical interface unit 151, and a second optical interface unit 155 transferring an optical signal between the processor 154 and a DRAM memory. The signal processor 141 may include a first electrical interface unit 152 (e.g., coupled to the electrical input and output part 122) and a second electrical interface unit 156 transferring an electrical signal between the processor 154 and a flash memory.

The controller 153 may control each block through control signals CTRL. The electrical interface or the optical interface may be used to provide the control signals CTRL.

FIG. 16 illustrates a block diagram of a memory expanding device according to example embodiments. Since an example embodiment of FIG. 16 includes similar components of the example embodiment of FIGS. 1, 8, and 12, the repeated descriptions may be omitted.

Referring to FIG. 16, the memory expanding device 160 may exchange information with an outside through an external optical interface OPText and an external electrical interface ELECText. Therefore, the memory expanding device 160 may include an optical input and output part 161 coupled to the external optical interface OPText, and an electrical input and output part 162 coupled to the external electrical interface ELECText. The controller 163 may be coupled to a plurality of DRAM modules 164a and 164b and a plurality of flash modules 165a and 165b.

The controller 163 may be coupled to the optical input and output part 161 through a first internal optical interface OPT1 and may be coupled to the electrical input and output part 162 through a first internal electrical interface ELECT1. The controller 163 may be coupled to the DRAM modules 164a and 164b through a second internal optical interface OPT2 and a second internal electrical interface ELECT2, and may be coupled to the flash modules 165a and 165b through a third internal electrical interface ELECT3.

In the case of the DRAM modules 164a and 164b, specific information requiring high operation speed, such as a data, may be transferred through an optical interface, e.g., through the second internal optical interface OPT2, and other information requiring low operation speed, such as a power supply, may be transferred through an electrical interface, e.g., through the second internal electrical interface ELECT2.

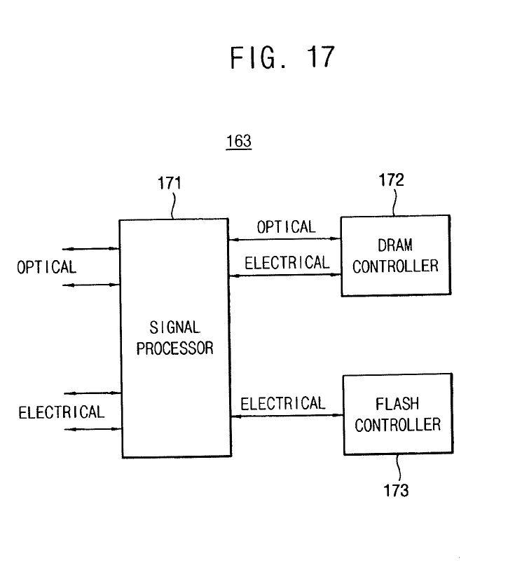

FIG. 17 illustrates a block diagram of an example of a controller included in the memory expanding device of FIG. 16.

Referring to FIG. 17, the controller 163 may include a signal processor 171 coupled to the optical input and output part 161 and the electrical input and output part 162 through an internal optical interface and an internal electrical interface, respectively. The controller 163 may include a DRAM controller 172 coupled to the signal processor 171 through an optical interface and an electrical interface, and a flash controller 173 coupled to the signal processor 171 through an electrical interface.

The signal processor 171 may transfer information concerned with DRAM through the optical interface or the electrical interface depending the sought after transmitting speed, and information concerned with flash through the electrical interface. Therefore, the signal processor 171 supports both of the optical interface and the electrical interface.

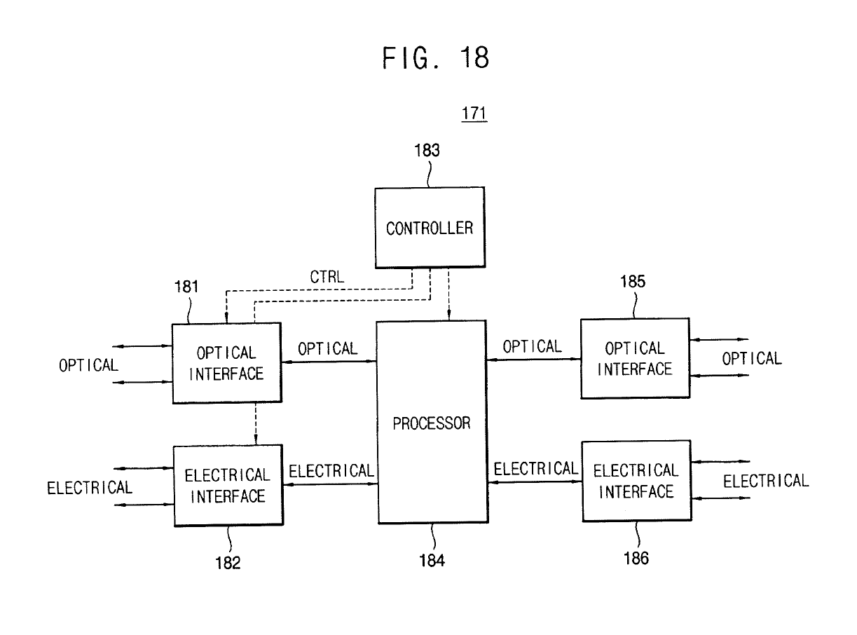

FIG. 18 illustrates a block diagram of an example of a signal processor included in the controller of FIG. 17.

Referring to FIG. 18, the signal processor 171 may include a first optical interface unit 181 (e.g., coupled to the optical input and output part 161), a processor 184 coupled to the optical interface unit 181, and a second optical interface unit 185 that transfers an optical signal between the processor 184 and a DRAM memory. The signal processor 171 may include a first electrical interface unit 182 (e.g., coupled to the electrical input and output part 162) and a second electrical interface unit 186 that transfers an electrical signal between the processor 184 and a flash memory and/or the DRAM memory. For example, the first and second electrical interface units 182 and 186 may be in communication with both the DRAM modules 164a and 164b and a plurality of flash modules 165a and 165b.

The controller 183 controls each block through control signals CTRL. The electrical interface and/or the optical interface may be used to provide the control signals CTRL.

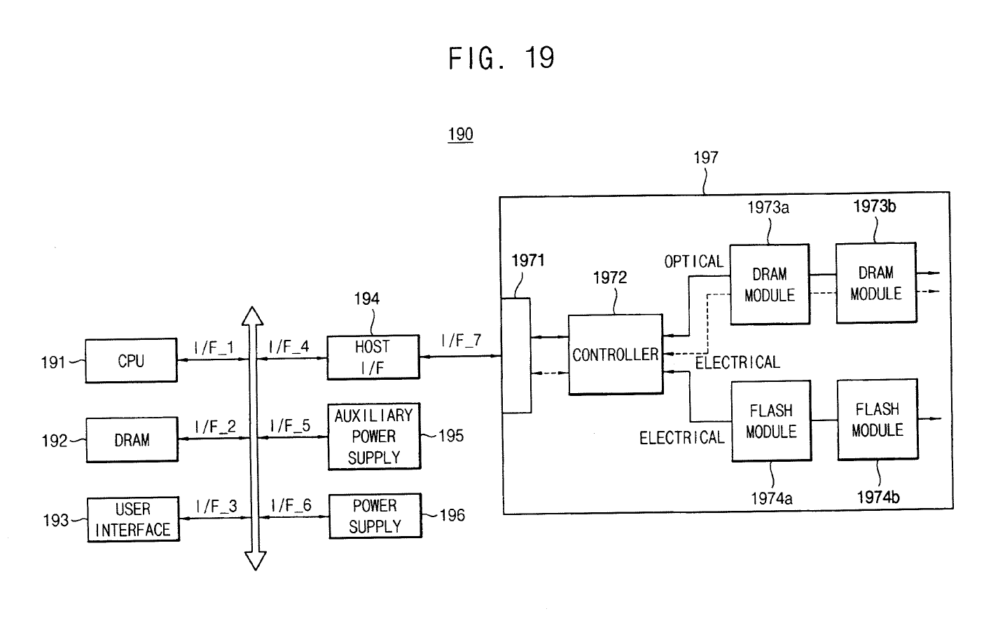

FIG. 19 illustrates a block diagram of an example of an electronic device including the memory expanding device according to example embodiments. In this case, the electronic device may be a personal computer, a laptop computer, a camera, and the like.

Referring to FIG. 19, the electronic device 190 may include a memory expanding device 197, a host interface unit 194, a power supply 196, an auxiliary power supply 195, a CPU 191, a DRAM 192, and a user interface unit 193.

Since the host interface unit 194 is coupled to the memory expanding device 197 through an optical interface I/F_{—}7, the host interface unit 194 may include an optical-electrical/electrical-optical conversion device. The memory expanding device 197 may be directly coupled to an external electrical interface according to an example embodiment. In this case, the optical interface I/F_{—}7 may further include an electrical interface.

The CPU 191, the DRAM 192, the user interface unit 193, the host interface unit 194, the auxiliary power supply 195, and the power supply 196 of FIG. 19 may be coupled to a system bus through internal interfaces I/F_{—}1, I/F_{—}2, I/F_{—}3, I/F_{—}4, I/F_{—}5, and I/F_{—}6, respectively. The internal interfaces I/F_{—}1, I/F_{—}2, I/F_{—}3, I/F_{—}4, I/F_{—}5, and I/F_{—}6 may include an electrical interface or an optical interface.

The memory expanding device 197 may include an input and output part 1971, DRAM modules 1973a and 1973b, and flash modules 1974a and 1974b. Although the DRAM modules 1973a and 1973b having an electrical interface and an optical interface, such as the memory expanding device shown in FIG. 16, is illustrated as an example in FIG. 19, the memory expanding device shown in FIG. 1, 8, or 12 may be applied.

As described above, the electronic device 190 according to example embodiments may be mounted externally on an electronic device through an optical interface and/or an electrical interface, so that main memory and sub-memory of the electronic device may be extended conveniently. Since the memory expanding device 190 is removable from the electronic device, the memory expanding device 190 may be used for a portable device.

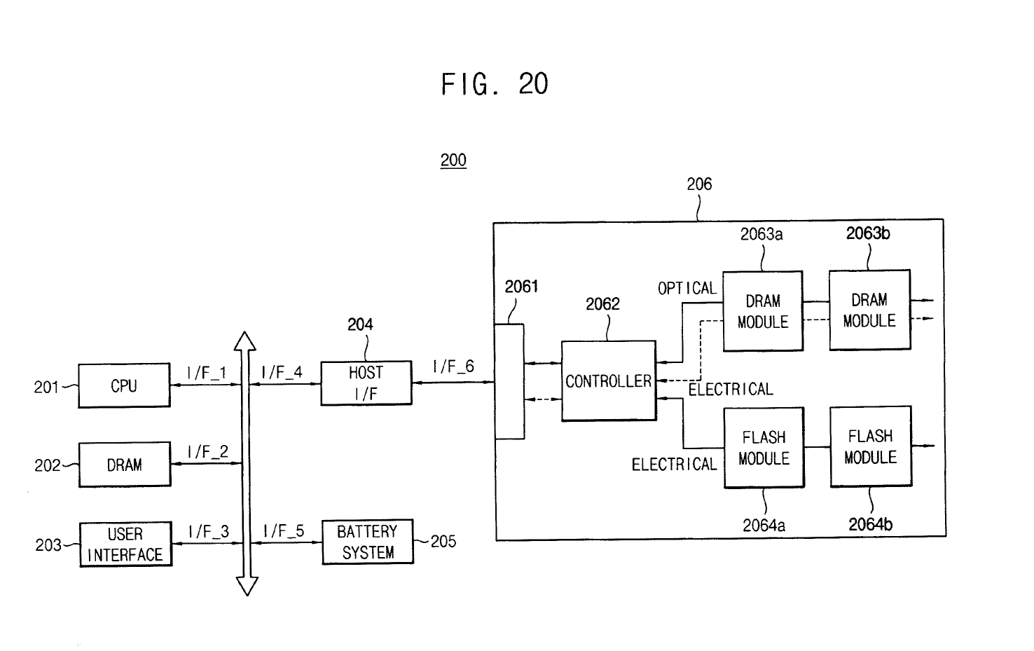

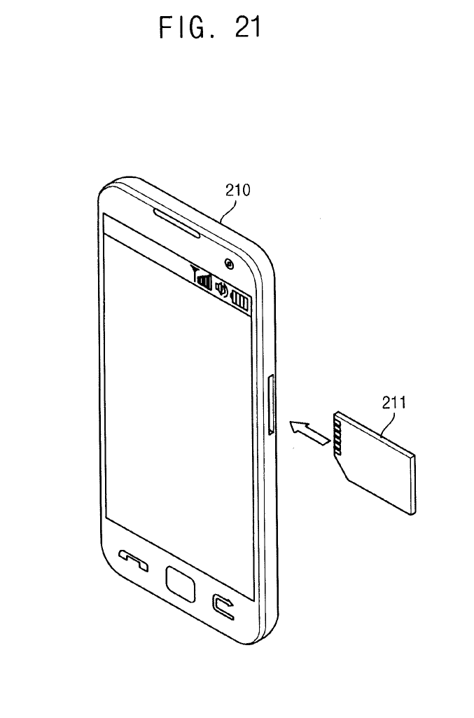

FIG. 20 illustrates a block diagram of another example of an electronic device including the memory expanding device according to example embodiments. In this case, the electronic device may be a portable device, such as a mobile phone, a laptop computer, a camera, and the like.

Referring to FIG. 20, the electronic device 200 may include a memory expanding device 206, a host interface unit 204, a battery system 205, a CPU 201, a DRAM 202, and a user interface unit 203.

Since the host interface unit 204 is coupled to the memory expanding device 206 through an optical interface I/F_{—}6, the host interface unit 204 may include an optical-electrical/electrical-optical conversion device. The memory expanding device 206 may be directly coupled to an external electrical interface depending on an example embodiment. In this case, the optical interface I/F_{—}6 may further include an electrical interface.

The CPU 201, the DRAM 202, the user interface unit 203, the host interface unit 204, the battery system 205 of FIG. 20 may be coupled to a system bus through internal interfaces I/F_{—}1, I/F_{—}2, I/F_{—}3, I/F_{—}4, and I/F_{—}5, respectively. The internal interfaces I/F_{—}1, I/F_{—}2, I/F_{—}3, I/F_{—}4, and I/F_{—}5 may include an electrical interface or an optical interface.

The memory expanding device 206 may include an input and output part 2061, DRAM modules 2063a and 2063b, and flash modules 2064a and 2064b. Although the DRAM modules 2063a and 2063b having an electrical interface and an optical interface, such as the memory expanding device shown in FIG. 16, is described as an example, the memory expanding device shown in FIG. 1, 8, or 12 may be applied.

FIG. 21 illustrates a block diagram of an example of a mobile phone including the memory expanding device according to example embodiments. Referring to FIG. 21, the memory expanding device 211 may be mounted to the mobile phone 210.

As described above, the mobile phone 210 according to example embodiments may be mounted on the electronic device through an optical interface and/or an electrical interface, so that main memory and sub-memory of the electronic device may be extended conveniently. In the case of the mobile phone 210, when an increase in the main memory and the sub-memory are sought according to increase the processing of data, the memory expanding device 211 may be mounted externally on the mobile phone 210. Therefore, capacity of the memory may be extended, and thus, the speed of processing of the electronic device may be increased. When the main memory is not required to be extended, e.g., when some processes are terminated, the memory expanding device 211 may be disabled or removed.

As described above, the memory expanding device 211 may use a high speed optical interface and the memory expanding device 211 may be removable. Therefore, the memory expanding device 211 may be more useful for portable devices, e.g., a mobile phone. The memory expanding device 211 may be coupleable to the mobile phone 210 through a wireless optical interface or a cable optical interface.

By way of summation and review, embodiments relate to a memory expanding device such as a memory card. For example, embodiments relate to a memory expanding device capable of increasing externally the capacity of main memory and sub-memory of an electronic device.

Some example embodiments relate to a memory expanding device that is capable of using a high speed optical connection technology to operate at low power consumption. The memory expanding device supports a high speed link, which may operate at the high bandwidth of a main memory device, to a central processing unit (CPU). Accordingly, the memory expanding device may be coupled to an external electronic device, which includes the CPU, to expand the capacity of the main memory in the electronic device.

Some exemplary embodiments relate to a memory expanding device that is configured to carry personal information and data. The memory expanding device may include a non-volatile memory, e.g., a flash memory, which preserves stored data even when power is off.

Some exemplary embodiments also relate to a memory expanding device that may be coupled to an electronic device from external to expand the capacity of the main memory in the electronic device. Further, the sub memory device may enhance portability of personal information.

Example embodiments have been disclosed herein, and although specific terms are employed, they are used and are to be interpreted in a generic and descriptive sense only and not for purpose of limitation. Further, although a few example embodiments have been described, those skilled in the art will readily appreciate that many modifications are possible in the example embodiments without materially departing from the teachings. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A memory expanding device, comprising:
an input and output part coupleable to an external optical interface;
a controller coupled to the input and output part through a first internal optical interface;
a main memory module coupled to the controller through a second internal optical interface; and
a sub-memory module coupled to the controller through a first internal electrical interface.

2. The memory expanding device as claimed in claim 1, wherein the input and output part is coupleable to an external electrical interface to exchange information with the sub-memory module through the external electrical interface.

3. The memory expanding device as claimed in claim 1, wherein the controller is further coupled to the main memory module through a second internal electrical interface.

4. The memory expanding device as claimed in claim 3, wherein the controller and the main memory module transfer data with each other through the second internal optical interface.

5. The memory expanding device as claimed in claim 4, wherein the controller and the main memory module transfer information that excludes the data with each other through the second internal electrical interface.

6. The memory expanding device as claimed in claim 1, wherein the controller includes:
a signal processor coupled to the input and output part through the first internal optical interface,
a main memory controller coupled to the signal processor through a third internal optical interface, and
a sub-memory controller coupled to the signal processor through a third internal electrical interface.

7. The memory expanding device as claimed in claim 6, wherein the signal processor includes a data converter configured to convert an optical signal into an electrical signal or to convert an electrical signal into an optical signal.

8. The memory expanding device as claimed in claim 1, wherein the main memory module includes a dynamic random access memory (DRAM) module or a magneto-resistive random access memory (MRAM) module.

9. A memory expanding device, comprising:
an input and output part coupleable to an external optical interface;
a controller coupled to the input and output part through a first internal optical interface;
a DRAM module coupled to the controller through a second internal optical interface; and
a flash memory module coupled to the controller through a first internal electrical interface or a second internal electrical interface.

10. The memory expanding device as claimed in claim 9, wherein, when the flash memory module is coupled to the first internal electrical interface, the controller includes:
a signal processor coupled to the input and output part through the first internal optical interface,
a DRAM controller coupled to the signal processor through a third internal optical interface, and
a flash memory controller coupled to the signal processor through the second internal electrical interface.

11. The memory expanding device as claimed in claim 10, wherein the signal processor includes a data converter configured to convert an optical signal from the input and output part into an electrical signal provided to the flash memory or to convert an electrical signal from the flash memory into an optical signal provided to the input and output part.

12. The memory expanding device as claimed in claim 9, wherein, when the flash memory module is coupled to the second internal electrical interface, the controller includes:
a signal processor that is coupled to the input and output part through the first internal optical interface,
a DRAM controller coupled to the signal processor through a third internal optical interface and the second internal electrical interface, and
a flash memory controller coupled to the signal processor through a fourth internal electrical interface.

13. The memory expanding device as claimed in claim 12, wherein the signal processor includes a data converter configured to convert an optical signal from the input and output part into an electrical signal provided to the DRAM memory or the flash memory or to convert an electrical signal from the DRAM memory or the flash memory into an optical signal provided to the input and output part.

14. The memory expanding device as claimed in claim 13, wherein the signal processor and the DRAM transfer data with each other through the third internal optical interface.

15. A memory expanding device removeably coupled to an external interface, the memory expanding device comprising:
a main memory module coupled to an controller through an internal optical interface, the main memory module including a plurality of first memory modules and being in communication with the external interface; and
a sub-memory module coupled to the controller through an internal electrical interface, the sub-memory module including a plurality of second memory modules that are separate from the first memory modules, the sub-memory module being in communication with the external interface.

16. The memory expanding device as claimed in claim 15, wherein the first memory modules are volatile memory modules, and the second memory modules are non-volatile memory modules.

17. The memory expanding device as claimed in claim 16, wherein:
the sub-memory module is only coupled to the controller through the internal electrical interface, and
the main memory module is coupled to the controller through the internal optical interface and another internal electrical interface.

18. The memory expanding device as claimed in claim 17, wherein, when the memory expanding device is coupled to the external interface, the controller is coupled to the external interface through another internal optical interface that is separate from the internal optical interface and the internal electrical interface.

19. The memory expanding device as claimed in claim 17, wherein the controller controls the first memory modules through an optical interface within the controller and an electrical interface within the controller, and the controller controls the second memory modules through the electrical interface within the controller.

20. The memory expanding device as claimed in claim 16, wherein:
the external interface is an external optical interface, and
the controller includes a data converter configured to convert an optical signal into an electrical signal provided to second memory modules and configured to convert an electrical signal from the second memory modules into an optical signal.
